(19) United States
(12) Patent Application Publication
(10) Pub. No.: US 2006/0001635 A1
(43) Pub. Date: Jan. 5, 2006

(54) Driver circuit and display device using the same

(75) Inventor: Keiichi Nakajima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/168,841

(22) Filed: Jun. 29, 2005

(30) Foreign Application Priority Data
Jun. 30, 2004 (JP) 2004-192987

(51) Int. Cl. G09G 3/36

(52) U.S. Cl. 345/98

(57) ABSTRACT

The driver circuit outputs a drive signal from an output terminal. The driver circuit has an output circuit and an output control circuit. The output circuit outputs either power supply voltage VDD2 or ground voltage VEE from the output terminal according to an input signal. While an output signal of the output circuit changes from first voltage to second voltage, the output control circuit drops the output voltage from supply voltage VDD2 to VDD2′ and then changes it to ground voltage VEE.

### BACKGROUND OF THE INVENTION

1. Field of the Invention

The present invention relates to driver circuits and display devices using the same and, particularly, to a driver circuit which outputs first voltage or second voltage to pixels and a display device using the same.

2. Description of Related Art

Active matrix liquid crystal displays and organic EL displays using a thin film transistor (TFT) rapidly become larger and larger. In the large size display devices, a line of a display panel where a TFT is formed is as long as several hundreds mm. Line resistance is therefore several tens kΩ order and causes significant waveform distortion to occur at the far end opposite to the near end where a driver circuit is connected.

If a gate waveform is different between the near end and the far end of the drive circuit in a gate line to which TFT gates of one line are commonly connected, feed-through voltage of each TFT differs between the near end and the far end. The difference in feed-through voltage of TFT causes the center voltage of a picture element connected to each TFT to vary. The variation in the center voltage leads to flicker to significantly deteriorate display quality.

Japanese Unexamined Patent Publication No. 2001-272654 (Miyajima et al.) describes a display device to overcome the above drawback. This display device delays the fall of a signal on a gate line to relatively reduce the waveform distortion at the near end and the far end of a gate driver, thereby equalizing feed-through voltage.

FIG. 5 shows a waveform of a gate line in the display device taught by Miyajima et al. It shows the waveforms of gate lines in previous and subsequent stages. In this waveform, the fall delays for a delay time period. If delay time of the falling waveform at the near end of the gate driver is t1 and a time constant of the gate line is t2, delay time t3 of the falling waveform at the far end of the gate driver is expressed as follows:
t3=\sqrt{(t1²+t2²)} Formula 1

If t1=1 μs and t2=3 μs, for example, substitution of these values into Formula 1 gives the following formula:
t3=\sqrt{(1×1+3×3)}=3.33 Formula 2

From Formula 2, a time difference of t3−t1=2.33 μs occurs between the near end and the far end of the gate driver. Further, if the delay time t1 of the falling waveform at the near end is 2 μs, for example, the following formula is given:
t3=\sqrt{(2×2+3×3)}=3.66 Formula 3

From Formula 3, a time difference of t3−t1=1.66 us occurs between the near end and the far end of the gate driver, which is shorter than the time difference in Formula 2. The difference means that feed-through voltage differs in the display panel. Thus, flicker or burn-in can occur unless the difference is reduced. Further, if the delay time is increased, the time when the gates of the previous and subsequent stages are on at the same time occurs, which causes failure to charge an image signal to a picture element properly.

To overcome this drawback, a method to switch the voltage output from the gate driver to VDD2′ which is lower than power supply voltage VDD2 immediately before the gate driver turns the gate from on to off. If VDD2′ is set to TFT threshold voltage, the effect of reducing variation in feed-through voltage stays the same.

A conventional gate driver IC using this method is described hereinafter with reference to FIGS. 6 and 7. FIG. 6 is a circuit diagram of a conventional gate driver IC, and FIG. 7 is a circuit diagram of an output circuit of the conventional gate driver IC.

A conventional gate driver IC 115 has a change register 116 with the same number of bits as the number of outputs of the gate driver IC 115. The outputs of the change register 116 are respectively connected to gate driver output circuits 117, and the gate driver output circuits 117 output the voltage for driving gate lines.

A driver power supply terminal 108 is connected to a selection switch 112 outside the gate driver IC 115. One selection terminal of the selection switch 112 is connected to a power supply circuit 110 with power supply voltage VDD2 as original gate drive voltage. The other selection terminal of the selection switch 112 is connected through a resistor 114 to a power supply circuit 111 set to power supply voltage VDD2′ which is lower than the power supply voltage VDD2 and higher than TFT threshold voltage.

A clock signal to scan a gate line is input to a CLK pulse input terminal 119. A start pulse signal to determine a timing for driving a gate line is input to a start pulse input terminal 118 and output from a start pulse output terminal 120.

As shown in FIG. 7, each gate driver output circuit 117 has a Pch transistor 101 and an Nch transistor 103 to form an inverter circuit. Gate electrodes of the Pch transistor 101 and the Nch transistor 103 are connected to each other and also to an input terminal 105. Their drain electrodes are connected to each other and also to an output terminal 107. A source electrode of the Pch transistor 101 is connected to the driver supply terminal 108, and a source electrode of the Nch transistor 103 is connected to ground voltage VEE.

The operation of the conventional gate driver IC 115 is described below. When a start pulse signal is applied to the start pulse input terminal 118 and a CLK pulse signal of one pulse is applied to the CLK pulse input terminal 119, the start pulse signal is input to the first bit of the change register 116. The output 1 of the gate driver output circuit 117 which is connected to the change register corresponding to the bit thereby changes from ground voltage VEE of off-level to power supply voltage VDD2 of on-level.

If the selection switch 112 is switched from the power supply circuit 110 to the power supply circuit 111 prior to input of a next CLK pulse signal, the level of the output 1 drops from power supply voltage VDD2 to power supply voltage VDD2′. At this time, reverse current 113 flows from the output 1 to the power supply terminal 108.

To drive the next gate line, the start pulse signal is turned low level and the next CLK pulse signal is input to the CLK pulse input terminal 119. The change register 116 thereby changes the previous high level to the next bit and thus the output 1 changes from power supply voltage VDD2′ to ground voltage VEE of off-level. At this time, the selection switch 112 is returned to the position of the power supply circuit 110. Further, since the signal of the change register 116 is changed to an adjacent bit, the output 2 changes from ground voltage VEE to power supply voltage VDD2. This operation is subsequently repeated until the final output n, thereby completing driving of the gate lines.

In this way, in the course of changing the voltage to drive the gate line from power supply voltage VDD2 to ground voltage VEE, power supply is switched to power supply voltage VDD2′, so that the output voltage changes from power supply voltage VDD2 to power supply voltage VDD2′ and then from power supply voltage VDD2′ to ground voltage VEE. This reduces the falling speed from power supply voltage VDD2 to VDD2′ while increasing the falling speed from power supply voltage VDD2′ to ground voltage VEE, thereby dropping the voltage in a short time.

However, in the conventional gate driver IC 115, when switching the voltage supplied to the driver power supply terminal 108 from power supply voltage VDD2 to VDD2′, current flows reversely from a connected gate line to the gate driver IC 115 to flow into the power supply circuit 111 of the power supply voltage VDD2′ through an internal parasitic diode as shown in FIG. 6 as reverse current 113. This causes latch-up in a MOS device to break down IC. Further, every time output voltage changes, significant transient current flows into a power supply of a driver circuit and power supply voltage thereby varies, causing errors to occur.

As described in the foregoing, the present invention has recognized that a conventional driver circuit such as a gate driver has a problem that changing output voltage to a plurality of voltage levels requires a plurality of power supply circuits and makes a circuit size larger. Further, it causes unstable operation due to reverse current flow into a power supply circuit upon switching of output voltage.

### SUMMARY OF THE INVENTION

According to one aspect of the present invention, there is provided a driver circuit outputting a drive signal for driving a plurality of pixels in a display device from an output terminal, which comprises an output circuit outputting from an output terminal one of first voltage supplied from a first power supply and second voltage supplied from a second power supply according to an input signal, the second voltage lower than the first voltage, and an output adjust circuit adjusting a resistance value between the output terminal and the second power supply while an output signal of the output circuit changes from the first voltage to the second voltage, to drop the output signal from the first voltage to third voltage between the first voltage and the second voltage and then from the third voltage to the second voltage.

Since this driver circuit changes output voltage from the first voltage to the second voltage in some stages, it is possible to reduce variation in feed-thorough voltage. Further, since the driver circuit changes resistance between the output terminal and the second power supply to drop the output voltage in multi steps, it eliminates the need for another power supply and suppresses an increase in power supply circuit size. It also prevents reverse current flow and achieves stable operation.

According to another aspect of the present invention, there is provided a driver circuit outputting a drive signal for driving a plurality of pixels in a display device, which comprises an inverter connected between a first power supply and a second power supply and outputting from an output terminal the drive signal of first voltage or second voltage according to an input signal, and an output adjust transistor connected between the output terminal with a power supply terminal of the second power supply and turned on while the drive signal changes from the first voltage to the second voltage.

Since this driver circuit changes output voltage from the first voltage to the second voltage in some stages, it is possible to reduce variation in feed-thorough voltage. Further, since the driver circuit changes resistance between the output terminal and the second power supply to drop the output voltage in multi steps, it eliminates the need for another power supply and suppresses an increase in power supply circuit size. It also prevents reverse current flow and achieves stable operation.

According to yet another aspect of the present invention, there is provided a display device comprising a display panel having a plurality of pixels and a plurality of lines transmitting signals to the plurality of pixels, and a driver circuit outputting drive signals to the plurality of pixels from output terminals through the plurality of lines. The driver circuit comprises output circuits each of which outputting from an output terminal one of first voltage supplied from a first power supply and second voltage supplied from a second power supply and lower than the first voltage according to an input signal, and output adjust circuits each of which adjusting a resistance value between an output terminal and the second power supply while an output signal of the output circuit changes from the first voltage to the second voltage, to drop the output signal from the first voltage to third voltage between the first voltage and the second voltage and then from the third voltage to the second voltage.

Since, in this display device, the driver circuit changes output voltage from the first voltage to the second voltage in some stages, it is possible to reduce variation in feed-thorough voltage. Further, since the driver circuit changes resistance between the output terminal and the second power supply to drop the output voltage in multi steps, it eliminates the need for another power supply and suppresses an increase in power supply circuit size. It also prevents reverse current flow and achieves stable operation.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a liquid crystal display device of the present invention;

FIG. 2 is a circuit diagram of an output circuit of a gate driver IC of the present invention;

FIG. 3 is a timing chart of an output circuit of a gate driver IC of the present invention;

FIG. 4 is a circuit diagram of an output circuit of a gate driver IC of the present invention;

FIG. 5 is a view showing an output waveform of a conventional gate driver IC;

FIG. 6 is a circuit diagram of a conventional gate driver IC; and

FIG. 7 is a circuit diagram of an output circuit of a conventional gate driver IC.

### DESCRIPTION OF THE PREFERRED EMBODIMENTS

### First Embodiment

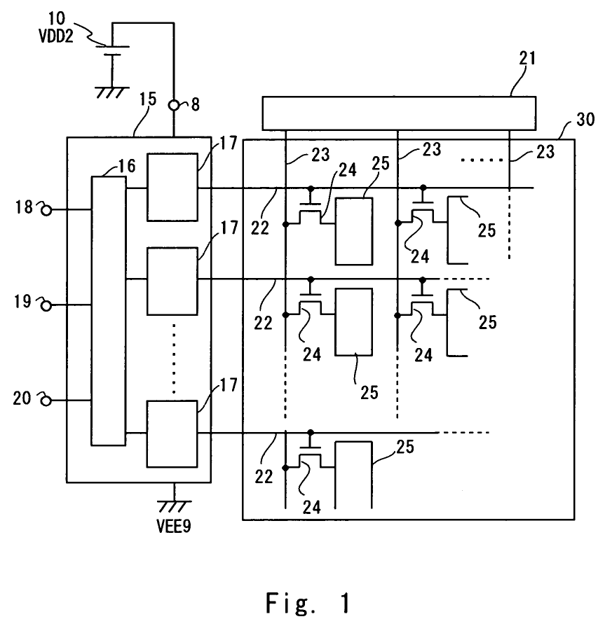

The configuration of a liquid crystal display device of a first embodiment of the invention is described hereinafter with reference to FIG. 1. The liquid crystal device has a display panel 30 that displays images with a plurality of pixels, a gate driver IC 15 that drives pixels through gate lines 22, and a source driver IC 21 that drives pixels through source lines 23.

The display panel 30 is, for example, an active matrix color liquid crystal panel that has a TFT as a switch element. The display panel 30 has gate lines (scan lines) 22 and source lines (data lines) 23 in the row and column directions, respectively, with a certain interval. The pixels are arranged in matrix at intersections of the gate lines 22 and the source lines 23.

Each pixel has a pixel electrode 25 as equivalent capacitive load through a TFT 24. The gates of the TFTs 24 in each column are commonly connected to the gate line 22. The sources of the TFTs 24 in each row are commonly connected to the source line 23. The drain of the TFT 24 is connected to the pixel electrode 25.

The gate driver IC 15 has a plurality of gate driver output circuits 17 each of which applies gate voltage to the gate line 22 and a change register 16 with the same number of bits as the number of the gate driver output circuits 17. Each gate driver output circuit 17 is connected to a first power supply 10 through a driver power supply terminal 8 to receive power supply voltage VDD2 and also connected to a second power supply 9 to receive ground voltage VEE. The change register 16 selects one from the plurality of gate driver output circuits 17 to set the output of the selected gate driver output circuit 17 to on-level at power supply voltage VDD2 while setting the outputs of the other gate driver output circuits 17 to off-level at ground voltage VEE.

A clock signal to scan a gate line is input to a CLK pulse input terminal 19. A start pulse signal to determine a timing for driving a gate line is input to a start pulse input terminal 18 and output from a start pulse output terminal 20.

For example, when a start pulse signal is applied to the start pulse input terminal 18 and a CLK pulse signal of one pulse is applied to the CLK pulse input terminal 19, the start pulse signal is input to the first bit of the change register 16, and Low is input to the gate driver output circuit 17 connected to the change register corresponding to the bit. Power supply voltage VDD2 is supplied from the first power supply 10 to the gate line 22. All the TFTs 24 connected to the gate line 22 are thereby turned on to enable writing to the pixel electrodes 25. Further, when a CLK pulse signal is applied to the CLK pulse input terminal 19 after a certain period of time, High is input to the gate driver output circuit 17 which has been outputting the power supply voltage VDD2. The voltage on the gate line 22 thereby drops to ground voltage VEE to turn off the gate of each TFT 24. After that, the gate line 22 in the next raw is driven.

The source driver IC 21 is connected to the plurality of source lines 23 to apply data voltage corresponding to a display image to each source line 23. Since the gates of the TFTs 24 connected to the gate line 22 driven by the gate driver IC 15 are open, the data voltage supplied to the source line 23 is written to the pixel electrodes 25 through the TFTs 24. The orientation of liquid crystal molecules corresponding to the pixel electrode 25 thereby changes to display a desired image.

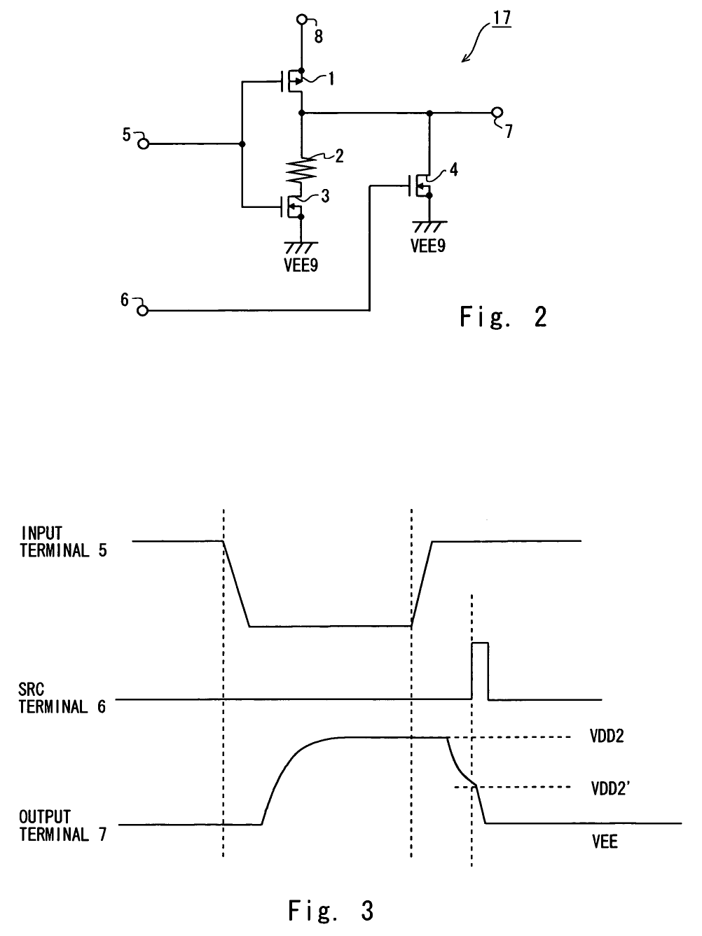

The configuration of the gate driver output circuit of this embodiment is described hereinafter with reference to the circuit diagram of FIG. 2. The gate driver output circuit 17 serves as an output section of the gate driver IC 15 of FIG. 1.

The gate driver output circuit 17 has a Pch transistor (first transistor) 1, a resistor 2, an Nch transistor (second transistor) 3, and an Nch transistor (third transistor) 4.

The source electrode of the Pch transistor 1 is connected to the driver power supply terminal 8. The drain electrode of the Pch transistor 1 is connected to one electrode of the resistor 2 and the drain electrode of the Nch transistor 4 while serving as an output terminal 7 by being drawn to the outside of the gate driver IC 15. As described above, the driver power supply terminal 8 is connected to the first power supply 10 with power supply voltage VDD2, and the output terminal 7 is connected to the gate line 22.

The drain electrode of the Nch transistor 3 is connected to the other electrode of the resistor 2. The source electrode of the Nch transistor 3 is connected to the second power supply 9 with ground voltage VEE. The gate electrode of the Pch transistor 1 is connected to the gate electrode of the Nch transistor 3 while serving as an input terminal 5 of the gate driver output circuit 17. The input terminal 5 is connected to the change register 16 to receive the output signal from the change register 16.

The source electrode of the Nch transistor 4 is connected to the second power supply 9 with ground voltage VEE. The gate electrode of the Nch transistor 4 is drawn to the outside of the gate driver IC 15 to serve as an SRC terminal 6. The SRC terminal 6 is connected, for example, to an external control circuit to receive a control signal from the control circuit.

The Pch transistor 1, the resistor 2, and the Nch transistor 3 form an inverter as an output circuit. In response to the signal input to the input terminal 5, the inverter outputs either power supply voltage VDD2 (first power supply voltage) or ground voltage VEE (second power supply voltage) from the output terminal 7.

The Nch transistor 4 changes the changing speed of the output signal of the output terminal 7 from power supply voltage VDD2 to ground voltage VEE in accordance with the signal input to the SRC terminal 6. Thus, the Nch transistor 4 is an output adjust circuit (output adjust transistor) and changes the output signal from power supply voltage VDD2 to VDD2′ and then from output voltage VDD2′ to ground voltage VEE.

In this embodiment, the Nch transistor 4 changes the changing speed of the output voltage by changing the resistance between the output terminal 7 and the ground voltage VEE. When the Nch transistor 4 is off, the voltage slowly changes from power supply voltage VDD2 to ground voltage VEE; on the other hand, when the Nch transistor 4 is on, the voltage rapidly changes from power supply voltage VDD2 to ground voltage VEE.

For example, on-resistance of the Nch transistor 4 may be smaller than the resistance value of on-resistance of the Nch transistor 3 and resistance of the resistor 2. Further, it is feasible to eliminate the resistor 2 and change the on-resistance by changing the sizes of the Nch transistors 3 and 4. The positions of the resistor 2 and the Nch transistor 3 may be replaced with each other.

The operation of the gate driver output circuit of the present invention is described hereinafter with reference to the timing chart of FIG. 3. FIG. 3 shows the waveforms of the signals on the input terminal 5, the SCR terminal 6, and the output terminal 7 of the gate driver output circuit 17 shown FIG. 2.

When the waveform input to the input terminal 5 changes from High to Low, the Pch transistor 1 is turned on and the Nch transistor 3 is turned off. Current thereby flows from the first power supply 10 to the output terminal 7 through the Pch transistor 1. The voltage level of the waveform output from the output terminal 7 therefore rises from ground voltage VEE to power supply voltage VDD2. At this time, the waveform on the SRC terminal 6 is Low and thus the Nch transistor 4 remains off.

Then, when the waveform input to the input terminal 5 changes from Low to High, the Pch transistor 1 is turned off and the Nch transistor 3 is turned on. Current thereby flows from the output terminal 7 to the second power supply 9 through the Nch transistor 3. The voltage level of the waveform output from the output terminal 7 therefore changes from power supply voltage VDD2 to ground voltage VEE. The falling edge slope of the waveform at this time is gentler and the voltage changes more slowly.

In the course of this changing, if the waveform input to the SRC terminal 6 is switched from Low to High, the Nch transistor 4 is also turned on so that current flows into the second power supply 9 through the Nch transistor 4 in addition to through the Nch transistor 3. The voltage level of the waveform output from the output terminal 7 thereby rapidly changes to ground voltage VEE. The falling edge of the waveform at this time is steeper and the voltage changes more rapidly. The duration from output voltage VDD2′ to ground voltage VEE is shorter than the duration from power supply voltage VDD2 to VDD2′. This prevents the gate voltage in the previous and subsequent stages from being on-state at the same time, thereby reducing display errors.

For example, when the voltage level of the waveform at the output terminal 7 drops to output voltage VDD2′, the waveform input to the SRC terminal 6 is switched from Low to High. Power supply voltage VDD2′ is lower than power supply voltage VDD2 and higher than TFT threshold voltage, or it may be TFT threshold voltage, preferably. A timing for switching the voltage level of the waveform at the output terminal 7 may be set by a control circuit which is designed by measuring a timing to reach output voltage VDD2′ in advance.

In this way, a plurality of Nch transistors are provided at the ground voltage VEE side of the gate driver output circuit and the total resistance is changed (reduced) to change a falling speed and form a step-like falling waveform, resulting in that current does not flow back into the power supply voltage VDD2 and thus latch-up is prevented from occurring. Namely, since a low drive capacity Nch transistor and a high drive capacity Nch transistor are employed in the driver output circuit to switch the falling speed of a gate drive waveform between two levels, it is possible to change the output waveform in step manner without changing the voltage applied to a drive power supply voltage terminal of the gate driver circuit.

Since the power supply of the driver circuit is not switched during operation, the circuit can operate stably. Specifically, since drive power supply voltage is constant, current from a load does not flow reversely into a power supply which causes latch-up, thus allowing stable operation. Though a conventional technique of FIG. 7 needs to place a power supply circuit with power supply voltage VDD2′, a selection switch and so on, this embodiment eliminates the need for these external circuits and only requires a power supply with power supply voltage VDD2. It is therefore possible to simplify the circuit configuration and reduces the costs of IC and display devices.

### Second Embodiment

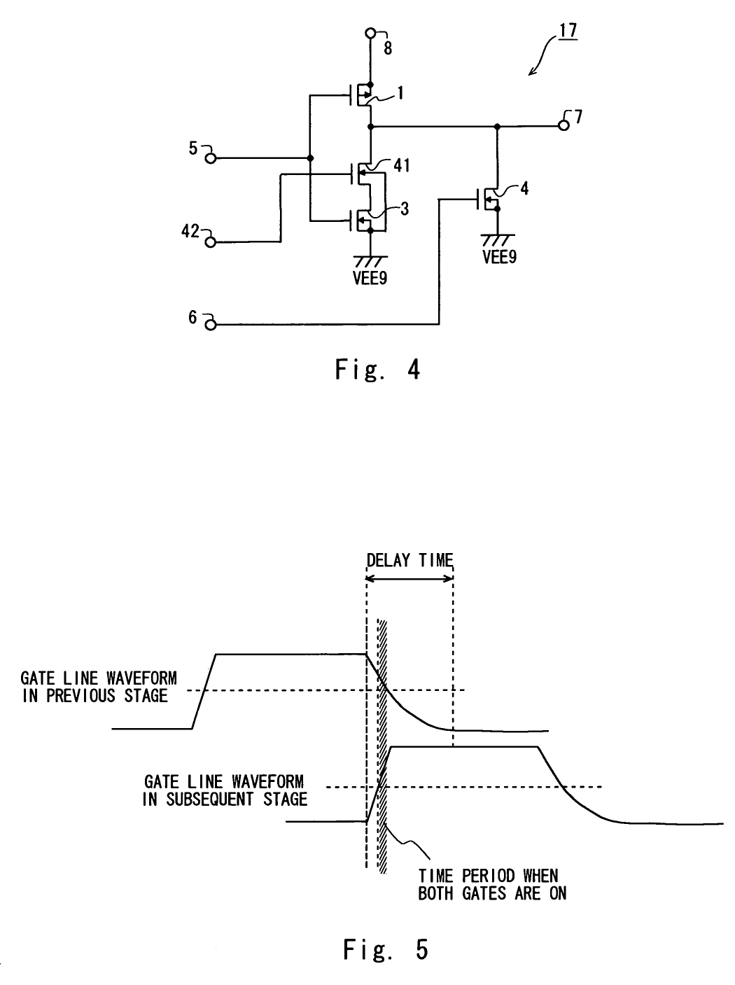

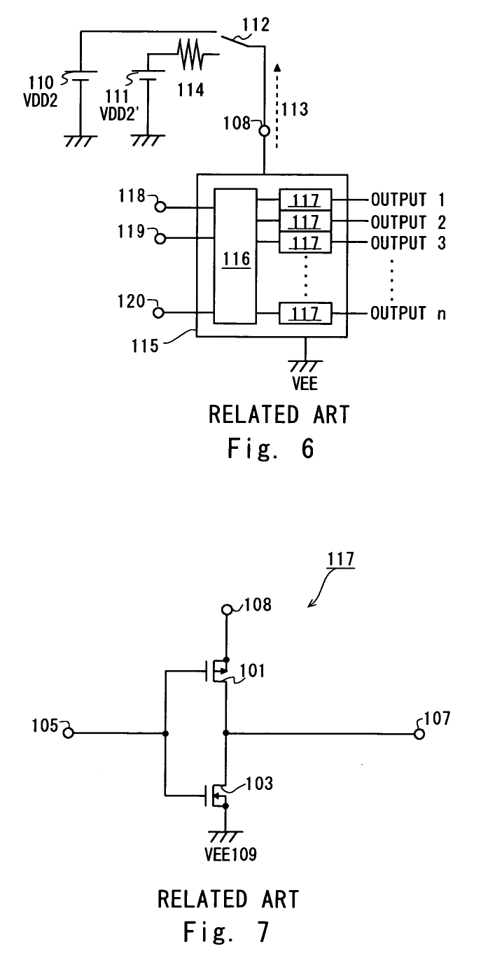

The configuration of a gate driver circuit according to a second embodiment of the invention is described hereinafter with reference to FIG. 4. The gate driver output circuit 17 is a circuit which serves as an output section of the gate driver IC 15 of FIG. 1.

In FIG. 4, the elements denoted by the reference symbols 1 and 3 to 9 are the same as those in FIG. 2. This embodiment replaces the resistor 2 of FIG. 2 with an Nch transistor (fourth transistor) 41.

The drain electrode of the Nch transistor 41 is connected to the drain electrode of the Pch transistor 1. The source electrode of the Nch transistor 41 is connected to the drain electrode of the Nch transistor 3. The gate electrode of the Nch transistor 41 serves as a control terminal 42 that controls a current capacity by receiving DC voltage from an external control circuit outside the gate driver IC 15.

The resistance of the Nch transistor 41 changes according to the DC voltage input to the control terminal 42, and it operates in the same way as the circuit of FIG. 2. The operation stays the same even if the positions of the Nch transistor 41 and the Nch transistor 3 are replaced with each other. It is further feasible that a signal which has been applied to the SRC terminal 6 is applied to the control terminal 42 and the Nch transistor 4 is eliminated.

Since a resistance value is fixed in the circuit of FIG. 2, it is necessary to design or produce a resistance value every time load-carrying capacity or threshold voltage of a connected TFT changes. This embodiment uses the Nch transistor instead of the resistor and supplies bias voltage from outside to the control terminal 42, thereby allowing the resistance between the drain and source of the Nch transistor 41 to change. Therefore, even when a falling waveform is changed according to a difference in load-carrying capacity or TFT, it is possible to change the waveform easily by applying external input voltage.

### Other Embodiments

Although the above embodiments drop the voltage level of an output waveform from output voltage VDD2′ to ground voltage VEE by a control signal applied to the SRC terminal 6 from outside of the gate driver IC, the present invention is not limited thereto, and the gate driver output circuit may have a control circuit to generate a control signal. For example, the control circuit may detect that the output level of the output terminal 7 reaches output voltage VDD2′.

Further, though the above embodiments describe the output circuit of a driver circuit of a liquid crystal display device, it may be a driver circuit of other display devices such as an organic EL display device.

It is apparent that the present invention is not limited to the above embodiment that may be modified and changed without departing from the scope and spirit of the invention.

What is claimed is:

1. A driver circuit outputting a drive signal for driving a plurality of pixels in a display device from an output terminal, comprising:
an output circuit outputting from an output terminal one of first voltage supplied from a first power supply and second voltage supplied from a second power supply according to an input signal, the second voltage lower than the first voltage; and
an output adjust circuit adjusting a resistance value between the output terminal and the second power supply while an output signal of the output circuit changes from the first voltage to the second voltage, to drop the output signal from the first voltage to third voltage between the first voltage and the second voltage and then from the third voltage to the second voltage.

2. The driver circuit of claim 1, wherein the output adjust circuit adjusts the resistance value according to an input control signal.

3. The driver circuit of claim 1, wherein duration from the third voltage to the second voltage is shorter than duration from the first voltage to the third voltage.

4. The driver circuit of claim 1, wherein the third voltage is threshold voltage of a thin film transistor formed in each of the plurality of pixels.

5. The driver circuit of claim 1, wherein
the output circuit comprises a first transistor connected between the first power supply and the output terminal and a second transistor connected between the second power supply and the output terminal,
the output adjust circuit comprises a third transistor connected between the second power supply and the output terminal, and
the output adjust circuit adjusts the resistance value between the output terminal and the second power supply using a control signal input to the third transistor.

6. The driver circuit of claim 5, wherein the third transistor is connected in parallel with the second transistor.

7. The driver circuit of claim 5, wherein on-resistance of the third transistor is smaller than on-resistance of the second transistor.

8. The driver circuit of claim 5, further comprising a resistor connected in serial with the second transistor between the second power supply and the output terminal.

9. The driver circuit of claim 8, wherein the resistor is a fourth transistor whose resistance value is variable according to an input signal.

10. A driver circuit outputting a drive signal for driving a plurality of pixels in a display device, comprising:
an inverter connected between a first power supply and a second power supply and outputting from an output terminal the drive signal of first voltage or second voltage according to an input signal; and
an output adjust transistor connected between the output terminal with a power supply terminal of the second power supply and turned on while the drive signal changes from the first voltage to the second voltage.

11. The driver circuit of claim 10, wherein the inverter comprises a first transistor connected between the first power supply and the output terminal and a second transistor connected between the second power supply and the output terminal, and the output adjust transistor is turned on after the second transistor is turned on.

12. The driver circuit of claim 10, wherein on-resistance of the output adjust transistor is smaller than on-resistance of the second transistor.

13. The driver circuit of claim 10, further comprising a resistor connected in serial with the second transistor between the second power supply and the output terminal.

14. The driver circuit of claim 13, wherein the resistor is a fourth transistor whose resistance value is variable according to an input control signal.

15. A display device comprising:
a display panel having a plurality of pixels; and
a driver circuit having a first terminal supplied with a first voltage level and a second terminal supplied with a second voltage level and outputting drive signals to convey the plurality of pixels, the first voltage level being higher than the second voltage level;
the driver circuit including,
a plurality of output circuits each having a first impedance path having a first impedance value between an output terminal thereof and the second terminal and a second impedance path having a second impedance value between the output terminal and the second terminal, the second impedance value being different from the first impedance value,
the output circuit driving the output terminal with the first impedance path then driving the output terminal with the second impedance path when a voltage level of the output terminal changes from the first voltage level to the second voltage level.
